(19) United States
(12) Patent Application Publication
(10) Pub. No.: US 2007/0121923 A1
(43) Pub. Date: May 31, 2007

(54) Telephone line communication interface

(75) Inventor: Reinhart Pildner, Brampton (CA)

Correspondence Address: Gerald Bluhm;Tyco Fire and Security, 50 Technology Drive, Westminster, MA, 01441, US

(73) Assignee: Tyco Safety Products Canada, Ltd.

(21) Appl. No.: 11/521,707

(22) Filed: Sep. 15, 2006

Related U.S. Application Data
(60) Provisional application No. 60/717,299, filed on Sep. 15, 2005.

(51) Int. Cl. H04M 9/00; H04M 1/00

(52) U.S. Cl. 379/394

(57) ABSTRACT

A telephone line communication interface (TLCI) module interfaces a security panel with a phone line of a phone network and comprises receive, transmit and hook control opto-couplers. The receive opto-coupler has receive input and output sides. Receive input side receives a signal on the phone line from the phone network and receive output side conveys the signal to the security panel. Transmit opto-coupler has transmit input and output sides. Transmit input side receives transmit signals from the security panel and the transmit output side conveys the transmit signal to the phone line of the phone network. The transmit output side is joined in parallel with the receive input side of the receive opto-coupler. The hook control opto-coupler has hook input and output sides. The hook input side receives a hook signal from the security panel. The hook output side has hook input and output lines. Hook output line drives a hook switch to convey the hook signal to the phone line of the phone network. Hook output side is joined serially with receive input side of the receive opto-coupler.

### CROSS REFERENCE TO RELATED APPLICATIONS

The application relates to and claims priority from provisional patent application Ser. No. 60/717,299, titled “Telephone Line Communication Interface,” filed Sep. 15, 2005, the complete subject matter of which is hereby incorporated by reference in its entirety. The application also relates to patent application Ser. No. 11/321,262, titled “Direct Access Arrangement Device,” filed Dec. 29, 2005, the complete subject matter of which is hereby incorporated by reference in its entirety.

### BACKGROUND OF THE INVENTION

This invention relates generally to alarm systems, and more generally to, a communication interface between an alarm system and a telephone network.

Security alarm systems are utilized in a variety of applications in both residential and commercial environments. Security alarms monitor one or more remote components and, based upon feedback from the remote components, carry out various security and emergency related functions. Security alarm systems typically communicate with one or more remote terminals, such as at a host or central operations terminal, over conventional phone lines maintained within the phone network.

Security alarm systems generally include a security panel joined to a modem that provides bidirectional communication over the phone network. The modem conveys security and emergency related data at various connection speeds (e.g. 2400 bps) between the phone network and the security panel.

A telephone line communication interface may be placed between the modem and/or the security panel, and the incoming phone line(s). The communication interface works to transfer control from the house phone to the security panel when the security panel requests to transfer data to a monitoring station over the phone network. Each phone network operates with a standardized profile of parameters such as line input and output levels, signal attenuation, line impedance and the like. One example of an average US line profile is a line impedance of 600 ohms, a line output level of approximately −23.5 dBm, a line input level of −10 dBm, and a line attenuation of 13.5 dBm. The communication interface provides the interface to the phone network by matching impedance levels, ring levels, and the like. Different countries and geographic regions have different line requirements which, in the past, have typically required many different build configurations of the communication interface which increases the cost.

The phone line typically has two wires interfacing with the communication interface which are referred to herein as TIP and RING. When the alarm system goes off-hook requesting a phone line, there is a level of voltage across TIP and RING. The tip-to-ring voltage may change based on the length of the phone line, wherein a longer phone line results in a lower tip-to-ring voltage as a longer phone line represents a higher resistance in the phone wire. Typically, communication interfaces have used a transmit opto-coupler and a receive opto-coupler connected in series with one another. A minimum amount of off-hook voltage is required for the opto-couplers to operate properly, thus limiting the operable length of the phone line.

Therefore, a need remains for a communication interface which meets the requirements of different countries with a minimal number of build configurations and which requires less tip-to-ring voltage when in an off-hook condition to enable operation over longer phone lines.

### BRIEF DESCRIPTION OF THE INVENTION

In one embodiment, a telephone line communication interface (TLCI) module is configured to interface a security panel with a phone line of a phone network and comprises receive, transmit and hook control opto-couplers. The receive opto-coupler has a receive input side and a receive output side. The receive input side includes a receive input line configured to receive a signal on the phone line from the phone network and the receive output side includes a receive output line configured to convey the signal to the security panel. The transmit opto-coupler has a transmit input side and a transmit output side. The transmit input side has a transmit input line configured to receive transmit signals from the security panel and the transmit output side has a transmit output line configured to convey the transmit signal to the phone line of the phone network. The transmit output side is joined in parallel with the receive input side of the receive opto-coupler. The hook control opto-coupler has a hook input side and a hook output side. The hook input side has a hook control line configured to receive a hook signal from the security panel. The hook output side has a hook input line and a hook output line. The hook output line activating a hook switch to convey the hook signal to the phone line of the phone network. The hook output side is joined serially with the receive input side of the receive opto-coupler.

In another embodiment, a security system comprises a security panel for performing control operations associated with at least one of security and emergency functions. A TLCI module is configured to interface the security panel with a phone network and comprises receive, transmit and hook control opto-couplers. The receive opto-coupler has a receive input side and a receive output side. The receive input side includes a receive input line configured to receive a signal on the phone line from the phone network and the receive output side includes a receive output line configured to convey the signal to the security panel. The transmit opto-coupler has a transmit input side and a transmit output side. The transmit input side has a transmit input line configured to receive transmit signals from the security panel and the transmit output side has a transmit output line configured to convey the transmit signal to the phone line of the phone network. The transmit output side is joined in parallel with the receive input side of the receive opto-coupler. The hook control opto-coupler has a hook input side and a hook output side. The hook input side has a hook control line configured to receive a hook signal from the security panel. The hook output side has a hook input line and a hook output line. The hook output line activates a hook switch conveying the hook signal to the phone line of the phone network. The hook output side is joined serially with the receive input side of the receive opto-coupler.

In another embodiment, a TLCI module is configured to interface a panel with a phone network and comprises receive, transmit and hook control opto-couplers, and means for matching impedance of the phone line of the phone network. The impedance of the phone line at least one of set at predetermined resistance and capacitance values and at least one range of resistance and capacitance values corresponding to at least one predetermined range of frequencies. The receive opto-coupler has a receive input side and a receive output side. The receive input side includes a receive input line configured to receive a signal on the phone line from the phone network and the receive output side includes a receive output line configured to convey the signal to the security panel. The transmit opto-coupler has a transmit input side and a transmit output side. The transmit input side has a transmit input line configured to receive transmit signals from the security panel and the transmit output side has a transmit output line configured to convey the transmit signal to the phone line of the phone network. The transmit output side is joined in parallel with the receive input side of the receive opto-coupler. The hook control opto-coupler has a hook input side and a hook output side. The hook input side has a hook control line configured to receive a hook signal from the security panel. The hook output side has a hook input line and a hook output line. The hook output line is configured to convey the hook signal to the phone line of the phone network.

### BRIEF DESCRIPTION OF THE DRAWINGS

FIG. 1 illustrates a block diagram of a security alarm system that is formed in accordance with an embodiment of the present invention.

FIG. 2 illustrates a block diagram of a portion of the TLCI module formed in accordance with an embodiment of the present invention.

FIG. 3 illustrates a block diagram of the TLCI module interconnected with the internal phone lines, external phone lines, and the security panel in accordance with an embodiment of the present invention.

FIG. 4 illustrates a schematic diagram of the TLCI module in accordance with an embodiment of the present invention.

FIG. 5 illustrates a chart of country/regions, corresponding telephone line impedance and tolerance requirements, and return loss requirements over the associated frequency range in accordance with an embodiment of the present invention.

FIG. 6 illustrates a chart of build options, associated country/regions, and examples of component values which may be used for the impedance matching network in accordance with an embodiment of the present invention.

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

### DETAILED DESCRIPTION OF THE INVENTION

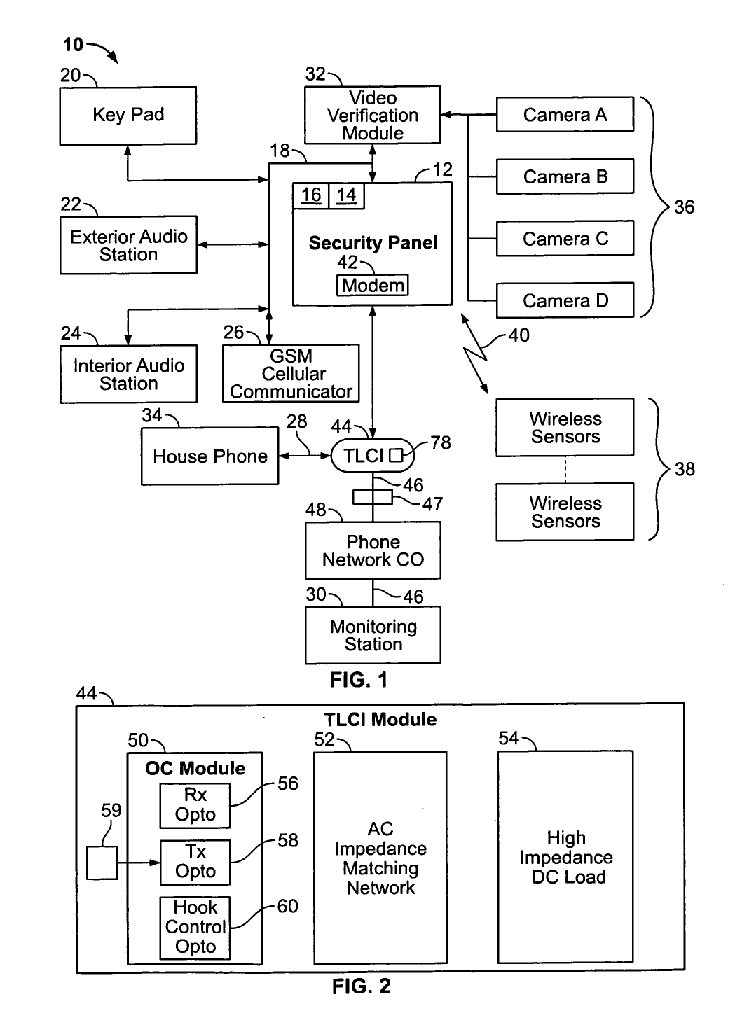

FIG. 1 illustrates a block diagram of a security alarm system 10 that is formed in accordance with an embodiment of the present invention. The system 10 includes a security panel 12 configured to perform various security and emergency related functions. The security panel 12 may include, among other things, a processor module 14, memory 16, and modem 42. A telephone line communication interface (TLCI) module 44 may interface with the modem 42 and/or the security panel 12, and may be integrated with, or separate from, the security panel 12. The TLCI module 44 is interconnected with external telephone (phone) lines 46 of a phone network central office (CO) 48 as well as internal phone line(s) 28 connected to house phone(s) 34. The security panel 12 may connect to and receive communications from a monitoring station 30 via the TLCI module 44, phone lines 46 and phone network CO 48. Voice and data are conveyed through the modem 42, TLCI module 44 and phone lines 46 bi-directionally.

The phone lines 46 have a line impedance 47 which is determined by the country or geographic area or region. Different line impedances 47 exist, and the TLCI module 44 has an impedance matching circuit 78 having components chosen to accommodate multiple countries and areas. Therefore, instead of each country requiring a different build of the TLCI module 44, a minimal number of build options, such as one, two or three build options, may be provided. Therefore, each build option is configured to meet the requirements of multiple countries or areas.

The security panel 12 communicates over a single, common communications bus 18 with various components, such as keypad 20, exterior audio station 22, interior audio station 24, GSM cellular communicator 26, video verification module 32, cameras 36 and the like. As shown in FIG. 1, the modem 42 is a separate component from the processor module 14. Optionally, the modem 42 may be part of the processor module 14. As a further option, the modem 42 may communicate with the processor module 14 over the bus 18 or over a separate dedicated bus (not shown). The security panel 12 may also be joined to wireless sensors 38 through a wireless link 40. The wireless link 40 may represent an RF link, an IR link and the like. The number of video cameras 36, key pads 20, exterior audio stations 22, interior audio stations 24, GSM cellular communicators 26, video verification modules 32, modems 42 and wireless sensors 38 may vary. The security panel 12 affords integrated audio and video features through the use of the communications bus 18 which carries control, event and configuration data, as well as audio and video data. Examples of audio and video features include audio intercom, video surveillance, video for intercom, audio verification of the alarm events, video verification of the alarm events and remote access of audio and video data. It is understood that all, or only a portion, of the audio and video features, and components illustrated in FIG. 1, may be provided and/or connected through the bus 18.

FIG. 2 illustrates a block diagram of a portion of the TLCI module 44. An opto-coupler (OC) module 50, AC impedance matching network 52, and high impedance DC load 54 are formed within. The OC module 50 comprises a receive opto-coupler 56 interconnected in parallel with a transmit opto-coupler 58. By placing the receive and transmit opto-couplers 56 and 58 in parallel, the dynamic range over which the TLCI module 44 can operate is increased. Performance may be improved by approximately 40% over configurations having the receive and transmit opto-couplers interconnected serially. Therefore, the TLCI module 44 will operate over longer phone lines 46 which have lower tip-to-ring voltages. In other words, the TLCI module 44 will work at lower voltages than previous configurations having the receive and transmit opto-couplers 56 and 58 interconnected serially with one another, and thus supports the use of longer phone lines 46.

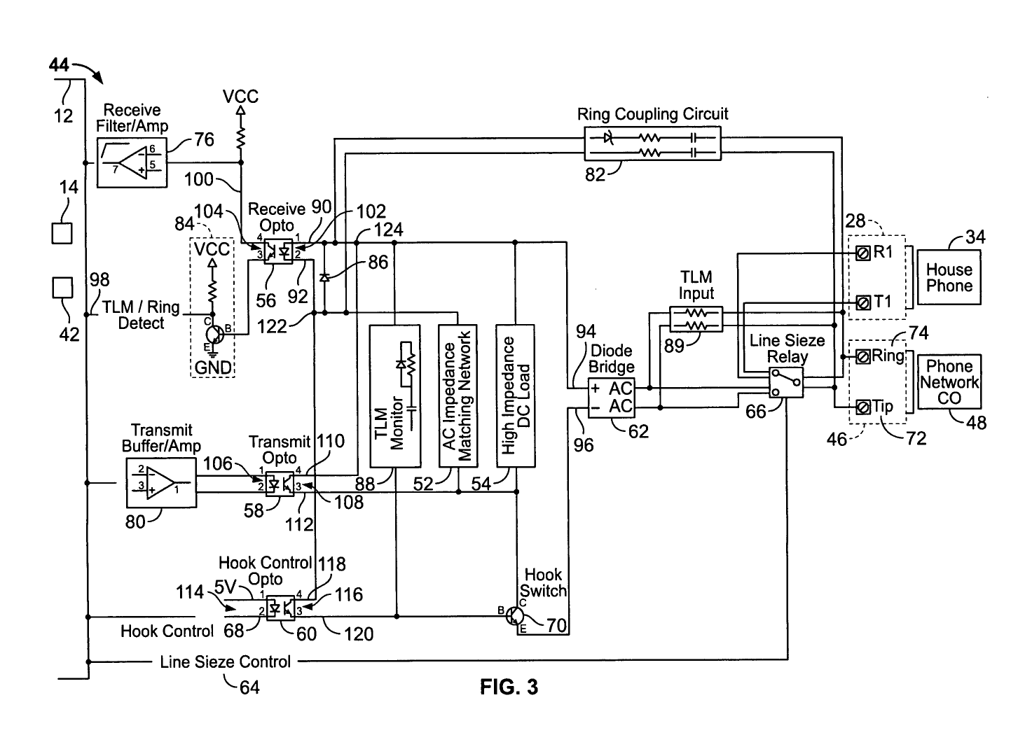

A hook control opto-coupler 60 is connected in series with the receive opto-coupler 56. The hook opto-coupler 60 is used to turn hook switch 70 (FIG. 3) on for off-hook and dial-pulse control. The receive and hook control opto-couplers 56 and 60 form a receive loop bias circuit.

The AC impedance matching network 52 comprises components having values which may be changed, if necessary, to provide the signal characteristics necessary for operation in different countries and areas. By carefully choosing the values, a minimal number of build configurations may be established to meet the requirements of each country and area as discussed previously, which minimizes the cost associated with producing multiple build configurations. With the exception of the AC impedance matching network 52, the TLCI module 44 may remain unchanged from one build to the next. Optionally, components within the high impedance DC load 54 may also be changed to vary the current characteristics and/or requirements of each country and area. Although illustrated separately in FIGS. 2 and 3, the AC impedance matching network 52 and the high impedance DC load 54 may comprise a sub-set of common components.

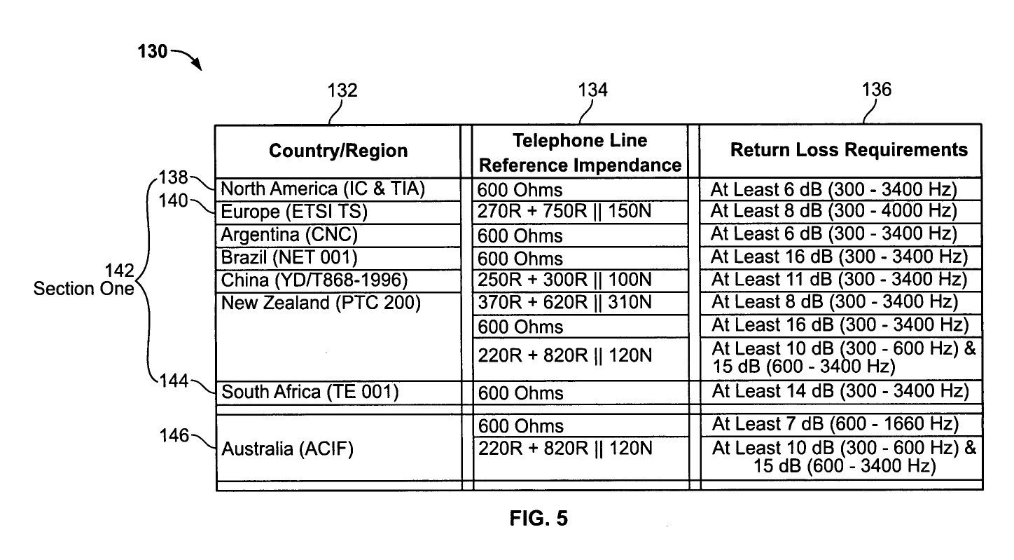

FIG. 5 illustrates a chart 130 of country/regions 132, corresponding telephone line reference impedance 134, and return loss requirements 136 over the associated frequency range. North America 138, for example, has an approximate 600 ohm line impedance requirement. Europe 140 has complex impedance having a range of impedance from approximately 466 ohms to approximately 889 ohms with an associated 150 nano-farad capacitance. By way of example, the 466 ohms is based on 270 ohms plus 750 ohms in parallel with 150 nF at a frequency of 4000 Hz, and the 889 ohms is based on 270 ohms plus 750 ohms in parallel with 150 nF at a frequency of 300 hz. Therefore, North America 138 has a first range of line impedance and Europe 140 has a second range of line impedance. By carefully choosing components within the impedance matching circuit 78, a first build option can meet the requirements of North America 138 and Europe 140, as well as the other countries listed in Section One 142. Second and third build options are used for South Africa 144 and Australia 146.

FIG. 3 illustrates a block diagram of the TLCI module 44 interconnected with the internal phone lines 28, phone lines 46, and the security panel 12. The TLCI module 44 may optionally be connected with the modem 42, processor module 14, and/or other interfacing and/or controlling component.

The receive, transmit, and hook control opto-couplers 56, 58 and 60 each include a light emitting diode (LED) that is located in proximity to a photosensitive transistor. For example, current is supplied to the LED in the receive opto-coupler 56 through receive input line 90 and flows out through return line 92. As the current varies, the brightness of the LED varies proportionally. The transistor in the receive opto-coupler 56 adjusts its conductivity based on the amount of exposed light. As the light from the LED increases, the current flow passed by the transistor increases linearly. The LEDs and transistors in the transmit and hook control opto-couplers 58 and 60 operate in a similar manner.

The receive opto-coupler 56 has a receive input side 102 (diode-side) and a receive output side 104 (transistor-side). The receive input side 102 has the receive input line 90 that receives the signal from the phone line 46 and the return line 92. The receive output side 104 has a receive output line 100 which conveys the signal to the security panel 12. The transmit opto-coupler 58 has a transmit input side 106 and a transmit output side 108. The transmit input side 106 has a transmit input line 110 that receives signals form the security panel 12, and transmit output line 112 which conveys the signal to the phone line 46. The hook control opto-coupler 60 has a hook input side 114 and a hook output side 116. The hook input side 114 includes a hook control line 68 that receives a hook signal from the security panel 12. The hook output side 116 has a hook input line 118 and a hook control output line 120.

The hook output side 116 is joined serially with the receive input side 102 of the receive opto-coupler 56, providing it with a constant current that remains the same regardless of telephone line voltage. Also, the AC signal from the phone line 46 from the negative voltage side 96 of the diode bridge 62 passes through the hook switch 70, the impedance matching network 52 via C91 to the receive input side 102 of the receive opto-coupler 56, then to the positive voltage side 94 of the diode bridge 62.

The receive opto-coupler 56 and the hook control opto-coupler 60 are connected serially at node 122 via the return line 92 and the hook input line 118. The transmit output side 108 of the transmit opto-coupler 58 in connected in parallel with the receive input side 102 of the receive opto-coupler 56 at node 124 via receive input line 90 and transmit input line 110, and also at the hook switch 70 across the high impedance DC load 54.

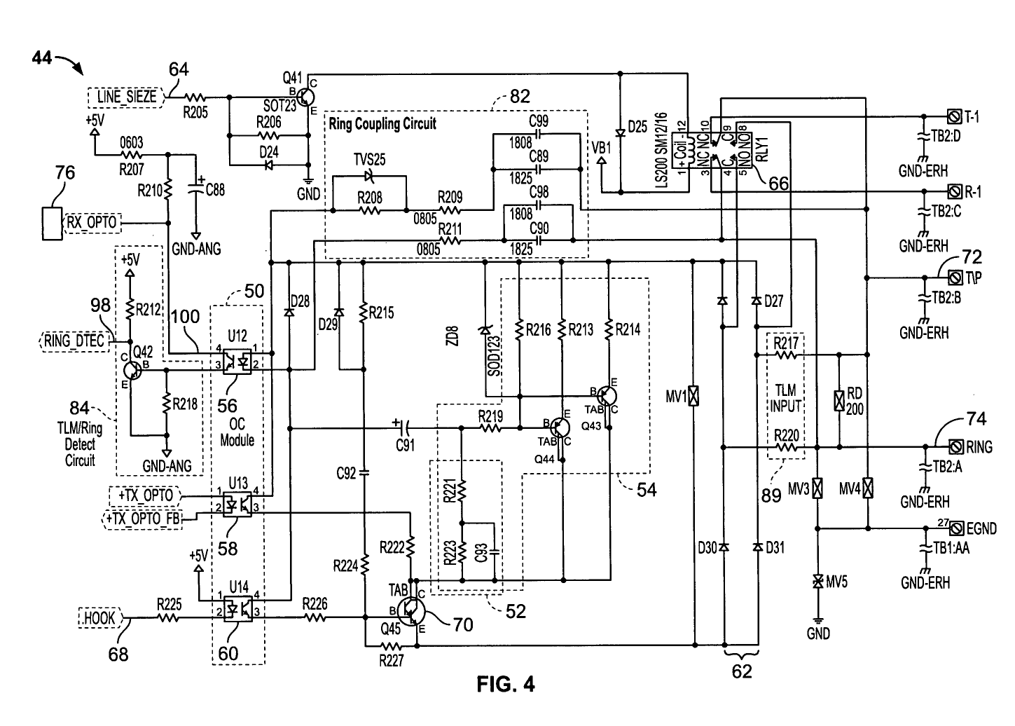

FIG. 4 illustrates a schematic diagram of the TLCI module 44. The schematic diagram represents a configuration having at least resistors, diodes, capacitors and transistors, each of which is denoted with an R, D, C or Q label, respectively, followed by a unique number. The receive, transmit and hook control opto-couplers 56, 58 and 60 within the OC module 50 are schematically represented as discrete components that are labeled U12, U13, and U14, respectively. The following discussion of the components in FIG. 4 will use some, but not all of these unique labels. FIGS. 3 and 4 will be discussed together.

In general, when the security panel 12 detects an alarm condition, it wishes to communicate with the monitoring station 30. The security panel 12 utilizes the TLCI module 44 to seize control of the phone line 46 and set an off-hook condition. The off-hook condition causes current to flow through TIP 72 and RING 74. The high impedance DC load 54 is connected across TIP 72 and RING 74 of the phone line 46, causing enough loop current to flow through the phone line 46 to indicate an off-hook condition to the phone network CO 48. The phone network CO 48 detects the off-hook condition and sends a dial tone on the phone line 46. When the security panel 12 detects the dial tone, the security panel 12 may use the modem 42 to dial the monitoring station 30 (FIG. 1) using DTMF, dial pulsing, and the like, depending upon the programming and requirements of the phone network CO 48. The AC impedance matching network 52 provides the impedance matching between the TLCI module 44 and the phone lines 46.

When the monitoring station 30 receives the call on the phone line 46, the monitoring station 30 transmits a hand shake tone. The security panel 12 detects the hand shake tone through the receive loop formed by receive and hook control opto-couplers 56 (U12) and 60 (U14), which are connected in series. The security panel 12 then may transmit and receive data using the transmit and receive opto-couplers 58 (U13) and 56 (U12). The monitoring station 30 may transmit one or more acknowledge signals to acknowledge receipt of transmitted data, as well as transmit other data as necessary. Bias for the transmit opto-coupler 58 is provided through transmit buffer/amplifier 80. The receive opto-coupler 56 is biased through the phone line 46 via the hook control opto-coupler 60.

More specifically, to gain control of the internal phone line 28, the security panel 12 sets line seize control 64 to HIGH which turns on Q41b. This energizes line seize relay 66 (RLY1) which transfers the phone line voltage of the phone lines 46 to diode or steering bridge 62 (comprising D26, D27, D30 and D31). The diode bridge 62 may also be referred to as a receive circuit. Thus, the line seize relay 66 (RLY1) transfers control of the phone line 46 from the house phone 34 to the security panel 12. If the house phone 34 is in use, it is disconnected by this transfer. This prevents anyone from compromising the communication of the alarm event to the monitoring station 30, either by accident or on purpose.

Receive and on/off-hook operations are controlled by the receive opto-coupler 56 (U12) and the hook control opto-coupler 60 (U14). An off-hook condition is initiated by setting hook control line 68 to LOW or zero volts. This causes current to flow through the diode of the hook control opto-coupler 60. Assuming a Current-Transfer-Ratio (CTR) of 100%, the current through the diode of the hook control opto-coupler 60 will be transferred to the collector (pin 4) of the hook control opto-coupler 60. The current passes through the diode of the receive opto-coupler 56, biasing the receive opto-coupler 56, and also into the base of the hook switch 70 (Q45). When the hook switch 70 turns on, the high impedance DC load 54 (comprising Q43, Q44, R213, R214, R216, R219, R221, R223, and C93) is connected across TIP 72 and RING 74 of the phone line 46, increasing the amount of loop current flowing through the phone line 46 to indicate an off-hook condition to the phone network CO 48. The AC signal sent through the phone line loop is picked up by the diode in the receive opto-coupler 56 (U12), transferred to the collector (pin 4) of the receive opto-coupler 56 (U12) (transistor side) and converted to a voltage, which is then received by output line 100 and detected by receive amplifier/high-pass filter 76, then passed to the security panel 12. The hand shake tone from the monitoring station 30 modulates current in the telephone loop.

The AC impedance matching network 52 to the phone line 46 comprises R221, R223 and C93. As illustrated in FIG. 4, the components R221, R223 and C93 are shared by the AC impedance matching network 52 and the high impedance DC load 54.

As discussed previously, different countries and areas require different impedance matching to work with the phone lines 72 when the phone line 46 is in an off-hook condition. Each country or geographic area has specified impedance parameters or ranges within which the equipment must work as illustrated in FIG. 5. For example, the phone line impedance may be 600 ohms in North America, and thus the impedance of the AC impedance matching network 52 is 600 ohms when the phone line 46 is in an off-hook condition. In contrast, Europe may have complex impedance in which the resistance value of the phone line 46 changes depending upon the frequency being transmitted. The frequencies across the range may be correlated to actual impedance values, such as along a curve. Components within the AC impedance matching network 52, as well as the high impedance DC load 54, are selected to satisfy the actual impedance.

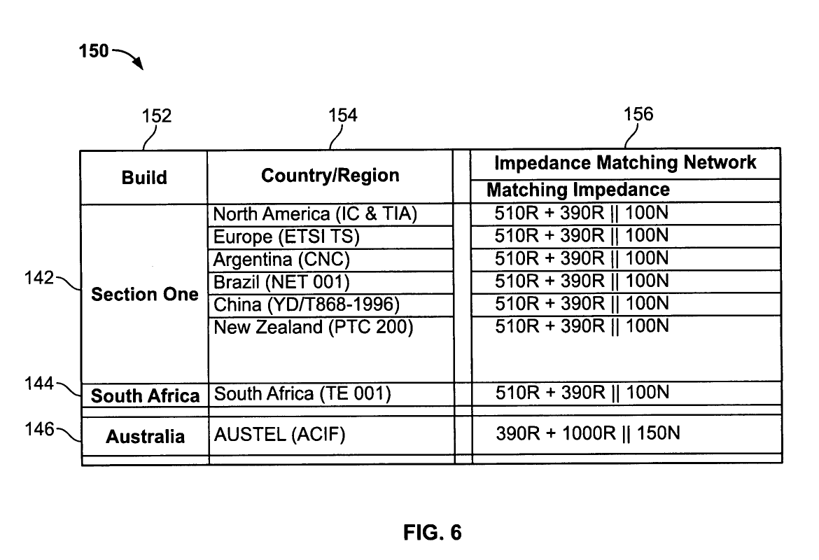

FIG. 6 illustrates a chart 150 of build options 152, associated country/regions 154, and examples of component values which may be used for the impedance matching network 156. Within the examples of the impedance matching network 156, each country/region has two corresponding resistor values indicated for R221 and R223 of the impedance matching network 52 (FIG. 4) and one capacitor value indicated for C93. For example, North America and Europe may both use resistor values of 510 ohms and 390 ohms with a capacitor value of 100 nano-farad. Each country/region 154 within Section One 142 may use the same resistor and capacitor values, even though the telephone line reference impedances 134 (FIG. 5) are not the same. This greatly reduces the overall number of different build options needed. Different resistor and capacitor values are used for South Africa 144 and Australia 146 to meet their particular requirements.

It should be understood that other countries/regions which are not listed may be included within any of the builds 152 of Section One 142, South Africa 144, and Australia 146 if the line impedance requirements are met. Also, different resistor and capacitor values may be used, as well as more than two resistors and/or more than one capacitor to meet the line impedance requirements. In addition, other components may be used within the impedance matching network 52 to meet the line impedance requirements.

When the security panel 12 wants to transmit data, the security panel 12 uses transmit buffer/amplifier 80 to bias on the transmit opto-coupler 58 (U13). The line seize control 64 is pulled HIGH, which transfers the phone line voltage to and through the diode bridge 62. Activating the hook control line 68 causes bias current to flow through the receive opto-coupler 56, hook control opto-coupler 60, and the hook switch 70. This turns on the high impedance DC load 54 which draws enough current to cause a detectable off-hook condition at the phone network CO 48. Due to the biasing of the transmit opto-coupler 58 and the current-transfer-ratio, the current that flows through the LED of the transmit opto-coupler 58 also flows from positive voltage side 94 (FIG. 3) of the diode bridge 62 through transmit opto-coupler 58, R222 (FIG. 4), and hook switch 70 to negative voltage side 96 of the diode bridge 62, out to RING 74, thus creating a transmit signal path or transmit loop to the phone line 46. As data is transmit through the transmit opto-coupler 58, the current flowing through the diode of the transmit opto-coupler 58 is modulated. This modulation is passed through to the transistor side where it modulates the current in the DC path as described above. This current modulation is then applied to the phone line 46 through the diode bridge 62. The data may be transmit in packets, pulse per second, F-tones, or other transmission protocol.

The security panel 12 also uses the TLCI module 44 to detect an incoming call or ring on the phone line 46. A ring detect or ring coupling circuit 82 may comprise the components C98, C99, R209, R211, TVS25, U12, and D28. The ring coupling circuit 82 indicated on FIG. 4 is for reference, and it should be noted that not all of the components are included for clarity. C98 and C99 are connected to RING 74 and TIP 72, respectively. The ring coupling circuit 82 may be changed to meet certain build requirements, such as for South Africa. When the security panel 12 is in an on-hook condition and a ring signal occurs across TIP 72 and RING 74, it is coupled into the TLCI module 44 through C98 and C99 of the ring coupling circuit 82. For example, the ring signal may be a sinewave, such as a 20 Hz sinewave having a 253 V peak-to-peak signal, typical. The ring current is limited by R209 and R211, and the sensitivity level of the ring signal is set by TVS25. When the ring signal is greater than the breakdown threshold of TVS25 (in the positive voltage direction) ring current flows through the LED of the receive opto-coupler 56. The ring signal is then coupled to the receive input side 102 of the receive opto-coupler 56 which drives Q42 of telephone line monitoring (TLM)/ring detect circuit 84 (which may be used as a level shifter). The output of the TLM/ring detect circuit 84 on line 98 is monitored by the security panel 12 to determine if a ring signal has occurred.

On the negative voltage cycle of the ring signal, TVS25 (of ring coupling circuit 82) and ring detect diode 86 (D28) are forward biased. The forward voltage across the ring detect diode 86, which is in parallel with the LED of the receive opto-coupler 56 makes sure that the LED of the receive opto-coupler 56 is off during the negative voltage cycle which then turns off the drive to the TLM/Ring detect circuit 84. In this way, the ring frequency across TIP 72 and RING 74 is isolated and coupled to the low voltage side and also level shifted for interfacing to the processor module 14.

The TLCI module 44 also provides for a telephone line monitoring (TLM) operation, which may be accomplished by TLM monitoring module 88 (comprising D26, D27, D30, D31, R215, D29, C92, R224, R227, and R226), TLM input 89 (comprising R217 and R220), as well as receive opto-coupler 56 and hook control opto-coupler 60. When the security panel 12 is in the on-hook condition, the phone line 46 will be monitored. During this time, TIP 72 and RING 74 voltage is applied to the TLM input 89, allowing a small amount of current to charge C92. When the security panel 12 wants to perform a TLM function, such as to determine if the phone line 46 is present, the hook control line 68 is pulled LOW to turn on the LED of the hook control opto-coupler, which then turns on the transistor of the hook control opto-coupler 60, thus providing a discharge path for C92 through the LED of the receive opto-coupler 56. The discharge of C92 through the LED of the receive opto-coupler 56 causes the LED to turn on, generates a pulse across pins 3 and 4 of the receive opto-coupler 56, and drives the TLM/ring detect circuit 84 (Q42) on. This pulse duration is applied to the security panel 12 via line 98. If the security panel 12 detects a pulse, the phone line 46 is deemed operable. If no pulse is detected at this time, the phone line 46 is deemed to be in a fault condition. The TLM function may be performed periodically, and the results displayed and/or logged at the security panel 12.

While the invention has been described in terms of various specific embodiments, those skilled in the art will recognize that the invention can be practiced with modification within the spirit and scope of the claims.

What is claimed is:

1. A telephone line communication interface (TLCI) module configured to interface a security panel with a phone line of a phone network, the TLCI module comprising:
a receive opto-coupler having a receive input side and a receive output side, the receive input side including a receive input line configured to receive a signal on the phone line from the phone network, the receive output side including a receive output line configured to convey the signal to a security panel;
a transmit opto-coupler having a transmit input side and a transmit output side, the transmit input side having a transmit input line configured to receive transmit signals from the security panel, the transmit output side having a transmit output line configured to convey the transmit signal to the phone line of the phone network, the transmit output side being joined in parallel with the receive input side of the receive opto-coupler; and
a hook control opto-coupler having a hook input side and a hook output side, the hook input side having a hook control line configured to receive a hook signal from the security panel, the hook output side having a hook input line and a hook output line, the hook output line activating a hook switch to convey the hook signal to the phone line of the phone network, the hook output side being joined serially with the receive input side of the receive opto-coupler.

2. The TLCI module of claim 1, further comprising an impedance matching network being interconnected with the receive input side of the receive opto-coupler and the transmit output side of the transmit opto-coupler, the impedance matching network configured to provide impedance matching with the phone network.

3. The TLCI module of claim 1, further comprising an impedance matching network being interconnected with the receive input side of the receive opto-coupler and the transmit output side of the transmit opto-coupler, the impedance matching network configured to provide an impedance of approximately 600 ohms to provide impedance matching with the phone network.

4. The TLCI module of claim 1, further comprising an impedance matching network comprising at least one resistor and one capacitor interconnected with one another, the impedance matching network being interconnected with the receive input side of the receive opto-coupler and the transmit output side of the transmit opto-coupler, the impedance matching network configured to provide impedance matching with the phone network.

5. The TLCI module of claim 1, the hook signal further comprising signals indicating on-hook and off-hook conditions, the TLCI module further comprising a high impedance DC load joined with the receive opto-coupler and the hook control opto-coupler, the high impedance DC load being configured to draw a level of current indicating to the phone network when the hook signal is in the off-hook condition.

6. The TLCI module of claim 1, further comprising an impedance matching network being interconnected with the receive input side and the transmit output side, the impedance matching network configured to provide an impedance of approximately 600 ohms to provide impedance matching with a first phone network, the impedance matching network further configured to provide complex impedance matching with a second phone network.

7. The TLCI module of claim 1, further comprising means for detecting a ring signal being transmitted on the phone network from a location remote from the TLCI module.

8. A security system, comprising:
a security panel for performing control operations associated with at least one of security and emergency functions; and
a telephone line communication interface (TLCI) module configured to interface the security panel with a phone network, the TLCI module comprising:
a receive opto-coupler having a receive input side and a receive output side, the receive input side including a receive input line configured to receive a signal on the phone line from the phone network, the receive output side including a receive output line configured to convey the signal to a security panel;
a transmit opto-coupler having a transmit input side and a transmit output side, the transmit input side having a transmit input line configured to receive transmit signals from the security panel, the transmit output side having a transmit output line configured to convey the transmit signal to the phone line of the phone network, the transmit output side being joined in parallel with the receive input side; and
a hook control opto-coupler having a hook input side and a hook output side, the hook input side having a hook control line configured to receive a hook signal from the security panel, the hook output side having a hook input line and a hook output line, the hook output line activating a hook switch conveying the hook signal to the phone line of the phone network, the hook input side being joined serially with the receive input side.

9. The system of claim 8, the TLCI module further comprising means for matching impedance of the phone network, the phone network comprising at least one of multiple phone networks located in at least one of multiple countries and multiple geographic regions.

10. The system of claim 8, the TLCI module further comprising means for matching impedance of the phone network, the impedance of the phone network being at least one of a predetermined resistance value and at least one range of resistance values corresponding to at least one predetermined range of frequencies.

11. The system of claim 8, wherein the hook signal further comprises on-hook and off-hook conditions, the TLCI module further comprising a high impedance DC load joined in parallel with at least the transmit output side of the transmit opto-coupler, the high impedance DC load being configured to draw a level of current to indicate to the phone network when the hook signal is in the off-hook condition.

12. The system of claim 8, the TLCI module further comprising an impedance matching network being interconnected with the receive input side and the transmit output side, the impedance matching network configured to provide an impedance of approximately 600 ohms to provide impedance matching with a first phone network, the impedance matching network further configured to provide complex impedance matching over a range of approximately 466 ohms to 889 ohms with a second phone network.

13. The system of claim 8, further comprising internal phone lines connecting the phone network to a house phone, the TLCI module further comprising means for transferring control of the phone network between the security panel and the house phone based on a control signal from the security panel.

14. The system of claim 8, wherein the transmit and receive opto-couplers are configured in parallel with one another to reduce a level of operational voltage required on the phone network.

15. A telephone line communication interface (TLCI) module configured to interface a panel with a phone network, the TLCI module comprising:
a receive opto-coupler having a receive input side and a receive output side, the receive input side including a receive input line configured to receive a signal on the phone line from the phone network, the receive output side including a receive output line configured to convey the signal to a security panel;
a transmit opto-coupler having a transmit input side and a transmit output side, the transmit input side having a transmit input line configured to receive transmit signals from the security panel, the transmit output side having a transmit output line configured to convey the transmit signal to the phone line of the phone network, the transmit output side being joined in parallel with the receive input side of the receive opto-coupler;
a hook control opto-coupler having a hook input side and a hook output side, the hook input side having a hook control line configured to receive a hook signal from the security panel, the hook output side having a hook input line and a hook output line, the hook output line being configured to convey the hook signal to the phone line of the phone network; and
means for matching impedance of the phone line of the phone network, the impedance of the phone line being at least one of set at predetermined resistance and capacitance values and at least one range of resistance and capacitance values corresponding to at least one predetermined range of frequencies.

16. The TLCI module of claim 15, wherein the transmit and receive opto-couplers are configured in parallel with one another to reduce a level of operational voltage required on the phone network.

17. The TLCI module of claim 15, wherein the hook input side is joined serially with the receive input side of the receive opto-coupler.

18. The TLCI module of claim 15, wherein the means for matching impedance is interconnected with the receive input side and the transmit output side, the means for matching impedance being configured to provide an impedance of approximately 600 ohms.

19. The TLCI module of claim 15, the hook signal further comprising signals indicating on-hook and off-hook conditions, the TLCI module further comprising a high impedance DC load joined with the receive opto-coupler and the hook control opto-coupler, the high impedance DC load being configured to draw a level of current that indicates to the phone network when the hook signal is in the off-hook condition.

20. The TLCI module of claim 15, further comprising internal phone lines connecting the phone network to a house phone, the TLCI module further comprising means for transferring control of the phone network between the security panel and the house phone based on a control signal from the security panel.
